(19) United States
(12) Patent Application Publication
(10) Pub. No.: US 2004/0120366 A1
(43) Pub. Date: Jun. 24, 2004

(54) Method of designing the cavity length of a tunable laser light source

(76) Inventors: Sean Chang, Taoyuan (TW); Chia-Chi Wu, Taipei (TW)

Correspondence Address: LAW OFFICES OF DAVID PAI, 1001 FOURTH AVENUE, SUITE 3200, SEATTLE, WA, 98154, US

(21) Appl. No.: 10/663,070

(22) Filed: Sep. 16, 2003

(30) Foreign Application Priority Data
Dec. 20, 2002 (TW) 91137005

(51) Int. Cl. H01S 3/08; H01S 3/10

(52) U.S. Cl. 372/20; 372/92

(57) ABSTRACT

A method of designing the cavity length for a tunable laser light source is disclosed. The performing steps are described as follows. Select a waveband for standard reference according to the International Telecommunication Union specification. Determine a constant that is a lowest multiplier for transforming all the frequencies among the band into integers. Set the optical path length of the cavity as the product of a positive number and half the product of the constant, a frequency, and the corresponding central wavelength. Then, dispose the cavity length according to the optical path length.

### BACKGROUND OF THE INVENTION

1. Field of the Invention

The invention relates to a method of designing a cavity length for a tunable laser light source, and more particularly, to a method of designing a specific optical path length for a tunable laser light source and thus determining the corresponding cavity length.

2. Description of the Related Art

To enhance the transmission efficiency of an optical communication system, a tunable laser light source is often used to output a light with a specific wavelength to carry the optical signal to be transmitted. In a conventional tunable laser light source, the tuning for the wavelength of the laser-excited light is achieved by mechanically adjusting the cavity length or controlling the temperature of the cavity.

As shown in FIG. 1A, the laser-excited light by a laser chip 2 on a silicon substrate 1 is converged into a parallel light beam 4 via a lens 3 according to a conventional tunable laser light source 10. An electrical heating regulator (EHR) 5 then tunes the wavelength of the light beam excited by the laser chip 2 on the basis of the temperature of the silicon substrate 1 sensed by a thermistor 6. Since the wavelength of the light beam is merely tuned according to the temperature of the silicon substrate, the tuned wavelength is always unsatisfying. Furthermore, the difficulty of low sensitivity due to the over-broad dynamic range occurs in controlling the wavelength. In view of this, an external-cavity-type tunable laser light source was proposed.

As shown in FIG. 1B, an external-cavity-type tunable laser light source 20 also includes an EHR 16 and a thermistor 17. Different from the tunable laser light source 10 mentioned above, the tunable laser light source 20 is provided with a semiconductor optical amplifier (SOA) 12, a lens 13, a tunable filter 14 and a plane mirror 15 on a silicon substrate 11. The total length Lt of the external cavity is the sum of the cavity length L₁ of the semiconductor laser 12, the distance L₂ between the semiconductor laser 12 and the lens 13, the thickness L₃ of the lens 13, the distance L₄ between the lens 13 and the tunable filter 14, the optical thickness L₅ of the tunable filter 14, and the distance L₆ between the tunable filter 14 and the plane mirror 15. As such, the total length Lt of the external cavity can be adjusted by controlling the temperature using the EHR 16 and adjusting the position of the plane mirror 15. As a result, the wavelength of the light beam of the tunable laser light source 20 can be tuned. Therefore, compared with the tunable laser light source 10 mentioned previously, the tunable laser light source 20 has a broader tunable band. In addition, the tunable laser light source 20 can output a light-wave within a specific channel with the aid of the tunable filter 14.

However, all the channels with a specific wavelength excited by the external-cavity-type tunable laser light source 20 mentioned above cannot completely conform to the standard wavelength grid defined by the International Telecommunication Union (ITU) under the basic tuning precision requirement of sub-micrometer order for a cavity length. To be more specific, there is a deviation between the channel of the laser beam excited by the tunable laser light source 20 and the ITU standard channel, and such deviation becomes larger when the number of the channels increases, as shown by the Δλ in FIG. 2. Therefore, the conventional methods of adjusting the cavity length mentioned above often incorporate an extra fine-tuning mechanism to ensure that the wavelength obtained conforms to the ITU standard channel. Nevertheless, that makes the control more difficult and time-consuming.

In view of the above, the invention proposes a method of designing the cavity length of a tunable laser light source. According to the method, the wavelength range of the laser beam excited covers all bands of a selected ITU specification, and each channel within the band conforms to the ITU standard channel. Furthermore, no extra fine-tuning mechanism is required and thus the tuning speed is accelerated.

### BRIEF SUMMARY OF THE INVENTION

An objective of the invention is to provide a method of designing the cavity length for a tunable laser light source, which solves the problems in the prior art.

Another objective of the invention is to provide a method of designing the cavity length for a tunable laser light source, which allows the tuning precision of the light beam output by a tunable laser light source to achieve a sub-micron order and satisfy the ITU specification.

Still another objective of the invention is to provide a method of designing the cavity length for a tunable laser light source, which makes each specific channel of a laser beam excited by a tunable laser light source conform to the ITU standard channel without deviations.

To achieve the abovementioned objectives, the method of designing the cavity length for a tunable laser light source according to the invention includes the following steps: selecting a waveband conforming to an International Telecommunication Union (ITU) grid specification; multiplying all the channel frequencies within the band by a minimum constant so that all the channel frequencies are converted into integers; setting the optical path length of the cavity to be the product of a positive integer number and half the product of the minimum constant, one channel frequency and the corresponding central wavelength; and configuring the cavity length according to the optical path length of the cavity.

In one aspect of the invention, the method further includes controlling the temperature of the cavity within a specific range using a temperature control unit, and compensating the cavity length for variations caused by assembly tolerance by employing a temperature compensating procedure. The temperature control unit may include an electrical heating regulator and a thermistor.

In another aspect of the invention, the cavity includes a plurality of optical components, such as a semiconductor laser, a lens, a tunable filter and a plane mirror. The configuring step is accomplished according to the optical path length of the cavity and refractive indices of the optical components.

According to the invention, the excited wavelength does not deviate from the standard channel. The cavity length only needs to be adjusted according to the temperature of the operating environment, and does not have to be adjusted according to the actual output wavelength. Therefore, the precision in controlling the wavelength can be enhanced, and the tuning speed can be improved without any fine-tuning mechanism.

### BRIEF DESCRIPTION OF THE DRAWINGS

FIG. 1A is a schematic diagram showing the configuration of the cavity of a tunable laser light source in the prior art.

FIG. 1B is a schematic diagram showing the configuration of the cavity of an external-cavity-type tunable laser light source in the prior art.

FIG. 2 is a schematic diagram showing the deviations between the wavelength output by the tunable laser light source in the prior art and the central wavelength of each standard ITU channel.

FIG. 3 is a flowchart showing the steps of the design method for the cavity length of a tunable laser light source according to an embodiment of the invention.

FIG. 4 is a flowchart showing the steps of the design method for the cavity length of an external-cavity-type tunable laser light source according to an embodiment of the invention.

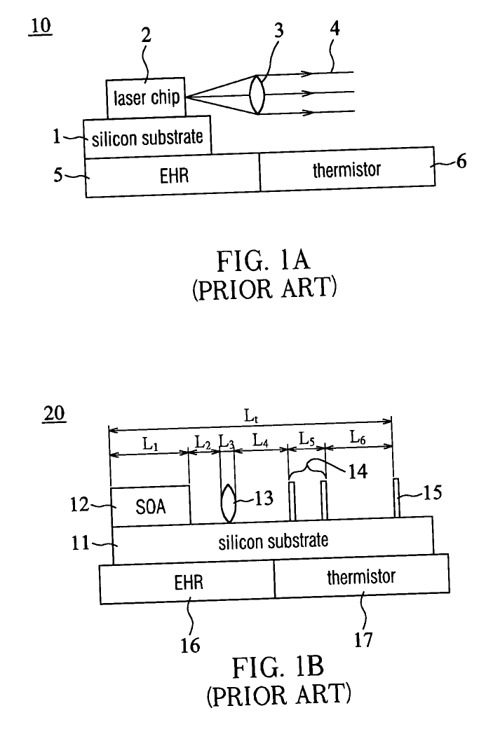

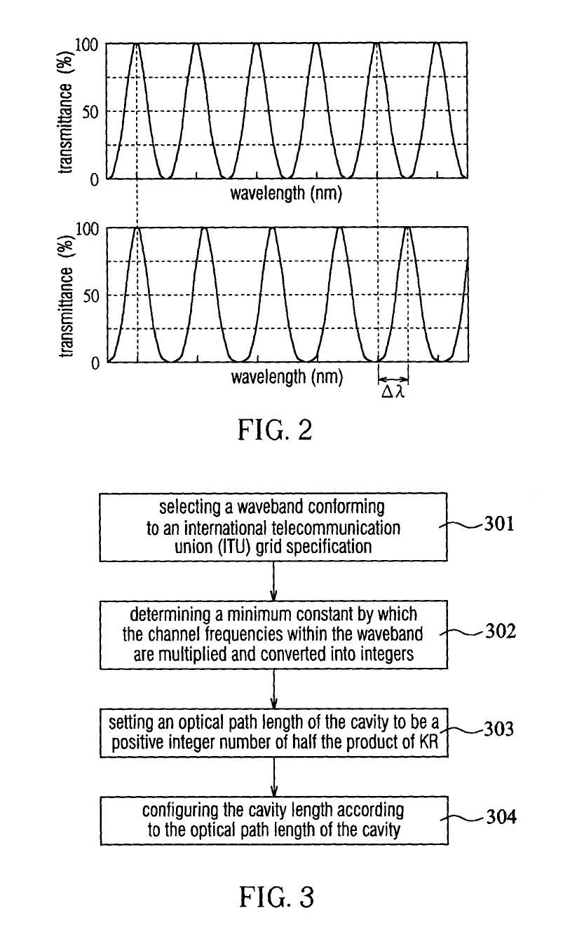

### DETAILED DESCRIPTION OF THE PREFERRED EMBODIMENT

As mentioned above, the invention provides a solution to the problem that the wavelength of the laser beam output by a tunable laser light source cannot conform to the ITU standard channel with a specific ITU grid. To make the wavelength of a laser beam output by a tunable laser light source conform to the entire ITU standard channel, the cavity length is designed on the basis of a common multiple of all ITU standard wavelengths. The embodiments of the invention will be described herein below with reference to the accompanying drawings.

It is known in the art that the cavity of a tunable laser light source is characterized by equation (1):

L=n×(λ/2) (1)

wherein L is the optical path length of the cavity, n is an arbitrary positive integer, and λ is the wavelength of the light beam.

Furthermore, the product of the wavelength λ and the frequency f of a light beam is a constant, as shown in equation (2):

R=f×λ (2)

wherein R is a constant. Therefore, in the ITU specification, the frequency of a light beam and its corresponding wavelength must satisfy equation (2).

Table 1 shows the range of the frequency and the wavelength under three different channel grids of ITU C band. Take the ITU C band with 50 GHZ channel grid as an example, the frequency range is 191 THZ˜195.95 THZ.

TABLE 1

| | | | | ITU | |
|---|---|---|---|---|---|
| ITU | | | | GRID 200 GHZ | |
| GRID 50 GHZ | | ITU GRID 100 GHZ | | | Wave- |
| Frequency | Wavelength | Frequency | Wavelength | Frequency | length |
| f (THZ) | λ (nm) | f (THZ) | λ (nm) | f (THZ) | λ (nm) |
| 191.00 | 1569.59 | 191.00 | 1569.59 | 191.00 | 1569.59 |
| 191.05 | 1569.18 | 191.10 | 1568.77 | 191.20 | 1567.95 |
| 191.10 | 1568.77 | 191.20 | 1567.95 | 191.40 | 1566.31 |
| 191.15 | 1568.36 | 191.30 | 1567.13 | 191.60 | 1564.68 |
| . | . | . | . | . | . |
| . | . | . | . | . | . |
| . | . | . | . | . | . |
| 195.80 | 1531.12 | 195.60 | 1532.68 | 195.20 | 1535.82 |
| 195.85 | 1530.72 | 195.70 | 1531.90 | 195.40 | 1534.25 |
| 195.90 | 1530.33 | 195.80 | 1531.12 | 195.60 | 1532.68 |
| 195.95 | 1529.94 | 195.90 | 1530.33 | 195.80 | 1531.12 |

First, according to Table 1, the frequency f corresponding to the central wavelength λ of each standard channel has a decimal portion. The frequency f can be converted into an integer by multiplying f by a constant K (step 302 of FIG. 3), and a lowest common multiple of the frequencies can be found, which is the product of the constant K, the frequency f and the wavelength A. The product is represented as KR.

Then, the optical path length L of the cavity of a tunable laser light source can be designed to be the product of a positive integer number and half the KR (step 303 of FIG. 3). Under this design, the channel wavelengths of the laser beam output by this tunable laser light source would conform to the central wavelengths of the ITU channels within a specific band (such as the C band) of the ITU specification.

Furthermore, the length of the cavity can be configured based on this specific optical path length (step 304 of FIG. 3). For example, the relationship between the refractive indices of the optical components in the cavity of the tunable laser light source and the optical path length is used. Take the ITU 50 GHZ specification as an example, the frequency grid of each channel is 0.05 THZ, thus the frequencies can be converted into integers by multiplying by the same minimum constant 20. Here, equation (2) becomes:

20R=(20f)×λ (3)

Compare equation (3) with equation (1), since 20f in equation (3) is an integer, (20f)×λ can be regarded as n×λ in equation (1). Therefore, the optical path length L of a cavity can be designed as n×λ×½ with reference to equation (1), that is, the positive multiple of (20f)×λ×1/2 or 10R. Similarly, for the ITU specifications of 25, 100 and 200 GHZ, one could design the optical path length L of a tunable laser light source as the multiple of 20R, 5R and 2.5R, respectively. FIG. 3 is a flowchart showing the design procedure of the optical path length of a tunable laser light source according to this embodiment of the invention.

Table 2 lists the central wavelength of each standard channel within the ITU 50 GHZ C band, the wavelength of the output by the cavity of the tunable laser light source according to the embodiment of the invention (wherein the optical path length of the cavity is 10R), and the wavelength of the laser beam output by a conventional external-cavity-type tunable laser light source (wherein the optical path length of the cavity is 3013.22 μm).

TABLE 2

| | Wavelength | |
|---|---|---|
| Central | output by the | |
| wavelength of | tunable laser | Wavelength |
| each standard | light source | output by the |
| channel within | according | tunable laser |
| the ITU 50 GHZ | to the | light source in |
| C band | embodiment | the prior art |
| (nm) | (nm) | (nm) |
| 1529.94 | 1529.94 | 1529.94 |
| 1530.33 | 1530.33 | 1530.33 |
| . | . | . |
| . | . | . |
| . | . | . |
| 1568.77 | 1568.77 | 1568.57 |
| 1569.18 | 1569.18 | 1568.98 |
| 1569.59 | 1569.59 | 1569.79 |

From Table 2, it is clear that there is almost no deviation between the central wavelength of each standard channel within the ITU 50 GHZ C band and the wavelength output by the tunable laser light source according to the embodiment of the invention. Therefore, using the cavity with the optical path length designed according to the method of the embodiment of the invention, the wavelength does not deviate from the standard channel. The cavity length only needs to be adjusted according to the temperature of the operating environment, and does not need to be adjusted according to the actual wavelength output. The precision for controlling the wavelength can be enhanced, and the tuning speed can be improved since no fine-tuning mechanism is required.

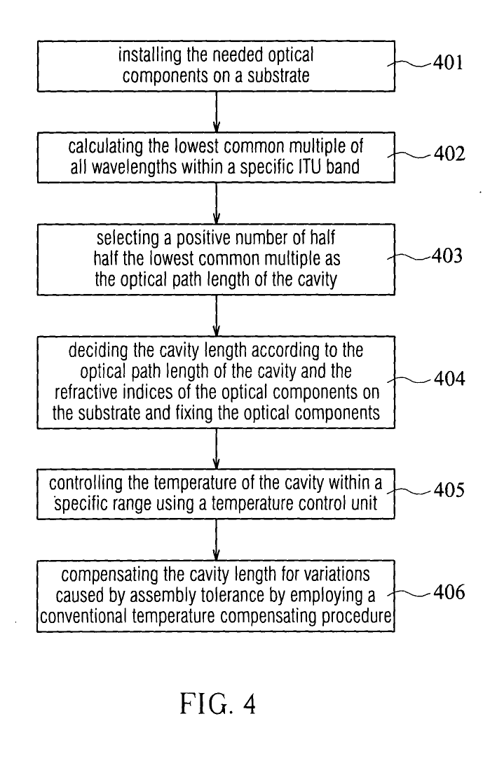

FIG. 4 is a flowchart showing the design method of the cavity length of an external-type tunable laser light source with a specific optical path length (such as 10R mentioned previously). First, in step 401, the optical components, such as a semiconductor laser, a lens, a tunable filter and a plane mirror are installed on a substrate. Then, in step 402, the lowest common multiple of all wavelengths within a specific ITU band is calculated using the above-described method. In step 403, a positive number of half the lowest common multiple is selected as the optical path length of the cavity. In step 404, the cavity length is designed and fixed with reference to the optical path length of the cavity and the refractive indices of the optical components on the substrate. In step 405, the temperature of the cavity is controlled within a specific range using a temperature control unit. Finally, in step 406, the cavity length is compensated for variations caused by assembly tolerance by employing a conventional temperature compensating procedure. It should be noted that the cavity length of the external-cavity-type tunable laser light source according to the present embodiment could be designed according to the ITU specification and band selected, and this method is suitable for all external-cavity-type tunable laser light source. Furthermore, since the wavelength deviation can be avoided naturally at the time that the cavity length of the tunable laser light source according to the embodiment is fixed, no extra wavelength compensating mechanism is needed during the operation.

While the invention has been described by way of examples and in terms of embodiments, it is to be understood that the invention is not limited to the disclosed embodiments, and is intended to cover various modifications. Therefore, the scope of the appended claims should be accorded the broadest interpretation so as to encompass all such modifications.

What is claimed is:

1. A method of designing the cavity length of a tunable laser light source, comprising the steps of:
selecting a waveband conforming to an International Telecommunication Union (ITU) grid specification;
determining a minimum constant by which the channel frequencies within the waveband can be multiplied to be converted into integers;
setting an optical path length of the cavity to be the product of a positive integer number and half the product of the minimum constant, a channel frequency and the corresponding central wavelength; and
configuring the cavity length according to the optical path length of the cavity.

2. The method according to claim 1, further comprising the step of:
controlling the temperature of the cavity within a specific range using a temperature control unit.

3. The method according to claim 2, further comprising the step of:
compensating the cavity length for variations caused by assembly tolerance.

4. The method according to claim 2, wherein the temperature control unit comprises an electrical heating regulator and a thermistor.

5. The method according to claim 1, further comprising the step of
installing a plurality of optical components.

6. The method according to claim 5, wherein the step of configuring the cavity length according to the optical path length of the cavity is accomplished according to the optical path length of the cavity and refractive indices of the optical components.

7. The method according to claim 5, wherein the optical components comprise a semiconductor laser, a lens, a tunable filter and a plane mirror.
